(19) United States
(12) Patent Application Publication
(10) Pub. No.: US 2010/0046409 A1
(43) Pub. Date: Feb. 25, 2010

(54) Signalling Control for a Point-To-Multipoint Content Transmission Network

(76) Inventors: Thorsten Lohmar, Aachen (DE); Juan-Antonio Ibanez, Solna (SE)

Correspondence Address: ERICSSON INC., 6300 LEGACY DRIVE, M/S EVR 1-C-11, PLANO, TX, 75024, US

(21) Appl. No.: 12/447,079

(22) PCT Filed: Oct. 26, 2006
(86) PCT No.: PCT/EP2006/010345

§ 371 Date: Oct. 12, 2009

(51) Int. Cl. H04H 20/71

(52) U.S. Cl. 370/312

(57) ABSTRACT

The invention relates to a technique for controlling a signalling for a point-to-multipoint (PTM) content transmission in a PTM-enabled network environment. A method embodiment of the invention comprises the steps of transmitting signalling information related to a PTM content transmission along a downstream signalling distribution tree (MSG) to a plurality of network access nodes; and receiving, in response to the signalling information, an aggregated feedback report from a feedback aggregation server separate from the downstream signalling distribution tree, wherein the aggregated feedback report is indicative of feedback reports from the plurality of network access nodes related to the signalling information.

### FIELD OF THE INVENTION

The invention generally relates to the field of point-to-multipoint content transmissions in a network environment, and in particular in a mobile network. More specifically, the invention relates to a technique for controlling a signalling for a point-to-multipoint content transmission.

### BACKGROUND OF THE INVENTION

Telephony and on-demand streaming services are examples for Point-to-Point (PTP) or unicast communication services. Broadcast and multicast services, on the other hand, are based on Point-To-Multipoint (PTM) communication. Using a PTM communication, content (such as voice, text, graphics or multimedia data) is transmitted from typically a single source to multiple destinations. PTM services might for example be streaming services or file delivery services.

The 3GPP (3^{rd}-Generation Partnership Project) has specified broadcast and multicast services for GSM (Global System for Mobile Communications) and UMTS (Universal Mobile Telecommunications System) networks, namely the Multimedia Broadcast and Multicast Service (MBMS) feature. This feature is documented for example in the 3GPP TS (Technical Specification) 23.246 and in TS 26.346. MBMS adds a plurality of broadcast/multicast-related techniques to conventional GSM or UMTS networks. For controlling these techniques, a dedicated MBMS control node is specified, which is called the broadcast/multicast service centre (BM-SC). Within MBMS, the BM-SC is responsible for providing and delivering broadcast/multicast services.

Downstream of the BM-SC, each node in the network has a list of further downstream nodes to determine to which nodes it should forward MBMS content. Thus, a hierarchically organized content distribution tree is created wherein the network access nodes serving a single radio cell form the leaves of the distribution tree. For instance in a GSM network, a base transceiver station (BTS) of a base station subsystem may form a network access node. In an UMTS network, the Node B stations in the radio access network may form the network access nodes.

The BM-SC serves as an entry point for content delivery, sets up and controls MBMS transport bearers, and initiates MBMS transmissions. For example, the BM-SC may provide the service announcements that signal an upcoming multicast transmission to the user equipment (UE) being member of the related group. These announcements include all necessary information such as multicast service identifier, Internet Protocol (IP) multicast addresses, time of transmission, and media descriptions that a user equipment needs to join a multicast session. Further signalling may be related to the actual start of a PTM content transmission, or “session”, to the session stop or to a session update.

The MBMS-related signalling is transported over PTP connections. For example, in a UMTS network, a GGSN (Gateway GPRS Support Node) acting as an edge gateway for the PTM content transmission may replicate a signalling message received from the BM-SC for all connected SGSNs (Serving GPRS Support Nodes), which further replicate the message to all connected RNCs (Radio Network Controllers)/BSCs (Base Station Controllers). In the upcoming UMTS LTE (Long Term Evolution) networks, presumably the BM-SC and/or an edge gateway (called access gateway within the LTE framework, e.g., an evolved GGSN) have to directly communicate signalling information with the network access nodes (e.g., evolved NodeBs). In any case, a potentially large number (e.g., several thousands) of signalling messages have to be constructed and transmitted by using the same number of unicast signalling connections. In particular in case of LTE, massive message replication and connection setup results in a significant processing delay between the first and the last of the signalling messages to be replicated.

A reliable PTM content transmission service requires that the network access nodes acknowledge reception of the PTM signalling by sending a feedback information to the PTM control node, i.e. the BM-SC and/or the edge gateway. However, transmission of feedback messages along the PTM distribution path via PTP messages loads the interconnecting links and nodes. The load is even increased if, for example, a feedback message is missing from one or more network access nodes. The PTM control node may then have to repeat the signalling transmission at least towards these network access nodes. The processing of a large number of feedback messages at the PTM control node leads to a further processing delay.

WO 03/094534 A2 describes a network environment enabled for multi-user multimedia messaging services. A multimedia message is distributed from an originator server to multiple recipients via one or more recipient servers, which execute a multicast delivery to the receiving user devices. The recipient server receives status messages from the user devices, each status message comprising an indication of a transmission state of the multimedia message at one of the user devices. The recipient server acts to aggregate the status indications into a report and sends the report to the originator server.

There is a need for an improved technique for PTM content transmission signalling in a PTM-enabled network environment.

### SUMMARY OF THE INVENTION

According to a first aspect of the invention, a method for controlling PTM content transmissions in a PTM-enabled network environment is proposed. The method comprises the steps of transmitting signalling information related to a PTM content transmission along a downstream signalling distribution tree to a plurality of network access nodes; and receiving, in response to the signalling information, an aggregated feedback report from a feedback aggregation server separate from the downstream signalling distribution tree, wherein the aggregated feedback report is indicative of feedback reports from the plurality of network access nodes related to the signalling information. The method may be performed in a PTM control node, for example a BM-SC and/or an edge gateway of the network.

The signalling information may comprise any information related to controlling a PTM content transmission. For example, the signalling information may comprise any information which is or may be included in a signalling message for controlling a PTM content transmission. In one implementation of the invention, the signalling information may indicate at least one feedback aggregation server. For example, the signalling information may comprise a list of aggregation servers. The signalling information may indicate a dedicated address of one or each feedback aggregation server. The receiving network access nodes may then use the address(es) to determine the aggregation server to which they direct their feedback. An address may for example be provided as an IP address or as a logical reference, e.g. a host name to be resolved via a DNS (Domain Name System).

The address may also be a multicast or anycast address, for example an IP multicast address, associated with multiple aggregation servers, or may be a logical reference which is resolved via DNS to one or more multicast addresses. The multicast address may be used by a PTM control node for signalling related to multiple PTM content transmissions. For example, in a network a single (“joint”) multicast address pointing towards a sub-network of aggregation servers may be used. Routing mechanisms may be implemented for routing of the multicast traffic (the feedback reports transmitted from the network access nodes towards the aggregation server sub-network) to meet traffic management conditions related to, e.g., load balancing. The multiple aggregation servers may form a server pool. The pool may comprise all or some aggregation servers of a network.

In one mode of the invention, the method comprises the further step of repeating, based on an evaluation of the received aggregated feedback report, the transmission of the signalling information. For example, the PTM control node may determine from the received aggregated feedback information one or more network access nodes which do not have received the signalling information. The repeated transmission may be performed based on a PTP service of the network environment, for example in cases in which only few network access nodes missed the first signalling transmission.

In one implementation of the invention, the signalling information comprises a feedback request indication such as a flag acting as an indicator. The feedback request indication may explicitly command a network access node to send or to refrain from sending a feedback.

In some variants of the invention, the signalling information is transmitted using a PTM service of the network environment. The signalling distribution tree may thus be based on the PTM service (or a small number of PTM services) instead of a potentially large number of unicast connections. For example, the access nodes may be members of one or more MBMS multicast groups configured specifically for the transport of signalling information.

According to a second aspect of the invention, a method of operating a network access node for handling point-to-multipoint (PTM) content transmissions in a PTM-enabled network environment is proposed. The method comprises the steps of receiving signalling information related to a PTM content transmission from a PTM control node, wherein the signalling information is received along a downstream signalling distribution tree; determining a feedback aggregation server separate from the downstream signalling distribution tree; and transmitting a feedback report related to the signalling information to the feedback aggregation server.

The network access nodes may be responsible for granting user terminals access to the network and may eventually deliver the content towards these terminals. The network access node may for example be implemented as a base transceiver station in a GSM network, a NodeB in an UMTS network, or an evolved NodeB in an UMTS LTE network.

According to one variant of the invention, the method comprises the step of determining the feedback aggregation server from the signalling information. For example, an address of the server or an address list comprising several servers may be included in a signalling message. In one representation of the invention, the signalling information indicates a multicast address associated with multiple feedback aggregation servers and the feedback report is transmitted using the multicast address.

Additionally or alternatively, the method may comprise the step of determining the address of the feedback aggregation server from a default list of feedback aggregation servers. An address of the feedback aggregation server may be different from an address of the PTM control node. For example, the feedback aggregation server may be a dedicated node or may be co-located with another network node, e.g. another network access node.

The feedback report may comprise at least one of an acknowledgement of received signalling information, an indication of a result of a process triggered by the received signalling information and status information related to the PTM content transmission. As an example, the received signalling may trigger the (re-)allocation of resources for the PTM content transmission. An indication of successful allocation may then be included in the feedback report. As another example, the network access node may provide a feedback indicating the reception of signalling information and may provide at later times further feedback information on a periodical basis indicating, e.g., a resource usage.

In one implementation of the invention, the step of determining the feedback aggregation server comprises selecting one server from a list of feedback aggregation servers. In one implementation of the invention, several addresses related to one or more access nodes may be available to the network access node, for example from the received signalling information as well as from a default list and possibly other sources. A decision algorithm has then to be implemented on the access node to decide which of the addresses shall be used. For example, a random selection may be performed.

In one implementation of the invention, the signalling information is received based on a first PTM service of the network environment. A second PTM service may then be used for conveying the PTM content transmission. The method may comprise the further step of identifying, based on a service identifier indicated by the received signalling information, the second PTM service of the network environment for the PTM content transmission.

According to a third aspect of the invention, a method of operating a feedback aggregation server in a PTM-enabled network environment is proposed, in which signalling information related to a PTM content transmission is transmitted from a PTM control node along a downstream signalling distribution tree to a plurality of network access nodes. The method may comprise the steps of receiving feedback reports responsive to the signalling information from a plurality of senders; aggregating the received feedback reports into an aggregated feedback report; and transmitting the aggregated feedback report; wherein the feedback aggregation server is separate from the downstream signalling distribution tree.

The plurality of senders may comprise at least one of one or more of the plurality of network access nodes and one or more lower-level feedback aggregation servers (or both). The feedback reports may comprise one or more feedback messages, e.g. acknowledgment messages, from the network access nodes or may comprise aggregated feedback reports from the lower-level aggregation servers. The feedback information may accordingly be received directly from the network access nodes or from other aggregation servers.

The aggregated feedback information may be transmitted towards the PTM control node. This may comprise sending the aggregated feedback information directly to the PTM control node, or may comprise sending the aggregated feedback information to a higher-level aggregation server.

One mode of the invention comprises the further step of receiving an indication of at least one of the PTM control node and a higher-level feedback aggregation server as a destination for the aggregated feedback report. In one variant of the invention, the indication may comprise an indication of a multicast address associated with multiple higher-level feedback aggregation servers. The indication may be received via an administrative intervention, or may be received in the form of a signalling information, e.g. from the PTM control node. As an example, the PTM control node may be indicated by the feedback reports received from the plurality of senders.

In one implementation of the invention, a list of higher-level feedback aggregation servers may be provided to the server, for example by administration or via signalling. The method may then comprise the step of selecting one server from the list of higher-level feedback aggregation servers. The selection may comprise to randomly choose a higher-level server. Additionally or alternatively, a different algorithm may be applied, which for example ensures load-balancing between the higher-level aggregation servers.

In some implementations of the invention, the method may comprise the further step of receiving assignment information indicating an assignment of an aggregation server functionality to the receiving node. Triggered by the reception of the assignment information, the receiving node may then locally instantiate the feedback aggregation server. Such a dynamic assignment of the role of a feedback aggregation server may be suitable, for example, in networks in which at least some of the feedback aggregation servers are co-located with other network nodes, e.g. network access nodes. The assignment information may be included within signalling information related to a particular PTM content transmission; for example, the signalling information may additionally indicate an MBMS session announcement or session start to a network access node.

In one representation of the invention, the aggregated feedback information may be transmitted at predetermined time intervals and/or after a predetermined number of feedback messages have been received. For example, the aggregation server may collect feedback reports from multiple network access nodes for a time interval of 10 seconds and may then transmit an aggregated feedback report towards the PTM control node.

According to a further aspect of the invention, a computer program product is proposed, which comprises program code portions for performing the steps of any one of the method aspects of the invention described herein when the computer program product is executed on one or more computing devices, for example on an aggregation server, a PTM control node or a network access node, such as a BTS or NodeB of a mobile network. The computer program product may be stored on a computer readable recording medium, such as a CD-ROM or DVD. Additionally or alternatively, the computer program product may be provided for download by a download server. The downloading may be achieved, for example, via the Internet.

According to a further aspect of the invention, a PTM control node is proposed, which is adapted for controlling PTM content transmissions in a PTM-enabled network environment. The the PTM control node comprises a transmission component adapted for transmitting signalling information related to a PTM content transmission along a downstream signalling distribution tree to a plurality of network access nodes; and a reception component adapted for receiving, in response to the signalling information, an aggregated feedback report from a feedback aggregation server separate from the downstream signalling distribution tree, wherein the aggregated feedback report is indicative of feedback reports from the plurality of network access nodes related to the signalling information. The transmission component may be adapted for transmitting the signalling information based on a PTM service of the network environment.

According to another aspect of the invention, a network access node is proposed, which is adapted for handling PTM content transmissions in a PTM-enabled network environment. The network access node comprises a reception component adapted for receiving signalling information related to a PTM content transmission from a PTM control node, wherein the signalling information is received along a downstream signalling distribution tree; a determination component adapted for determining a feedback aggregation server, wherein the feedback aggregation server is separate from the downstream signalling distribution tree; and a transmission component adapted for transmitting a feedback report related to the signalling information to the feedback aggregation server.

According to a still further aspect of the invention, a feedback aggregation server is proposed, which is adapted for a PTM-enabled network environment, in which signalling information related to a PTM content transmission is transmitted from a PTM control node along a downstream signalling distribution tree to a plurality of network access nodes. The feedback aggregation server comprises a control component adapted for receiving feedback reports responsive to the signalling information from a plurality of senders; an aggregation component adapted for aggregating the received feedback reports into an aggregated feedback report; and a transmission component adapted for transmitting the aggregated feedback report; wherein the feedback aggregation server is separate from the downstream signalling distribution tree. The feedback aggregation server may be co-located with a network access node. Additionally or alternatively, the feedback aggregation server may be associated with a PTM control node.

### BRIEF DESCRIPTION OF THE DRAWINGS

In the following, the invention will further be described with reference to exemplary embodiments illustrated in the figures, in which:

FIG. 1A schematically illustrates an embodiment of a PTM-enabled network;

FIG. 1B schematically illustrates an embodiment of a control multicast group in the network of FIG. 1A;

FIG. 1C schematically illustrates an embodiment of a sub-network of feedback aggregation servers for the PTM-enabled network of FIG. 1A;

FIG. 1D schematically illustrates a further embodiment of a PTM-enabled network with a sub-network of feedback aggregation servers;

FIG. 2 is a functional block diagram schematically illustrating an embodiment of an aggregation server;

FIG. 3 is a functional block diagram schematically illustrating an embodiment of a PTM control node;

FIG. 4 is a functional block diagram schematically illustrating an embodiment of a network access node;

FIG. 5 is a flow chart illustrating steps of a method embodiment of operating a feedback aggregation server;

FIG. 6 is a flow chart illustrating steps of a method embodiment for controlling PTM content transmissions;

FIG. 7 is a flow chart illustrating steps of a method embodiment of operating a network access node for handling PTM content transmissions; and

FIG. 8 is a sequence chart illustrating an embodiment of a signalling message flow related to a PTM content transmission.

### DETAILED DESCRIPTION OF PREFERRED EMBODIMENTS

In the following description, for purposes of explanation and not limitation, specific details are set forth, such as specific network architectures including particular network nodes, communication techniques etc., in order to provide a thorough understanding of the current invention. It will be apparent to one skilled in the art that the current invention may be practised in other embodiments that depart from these specific details. For example, the skilled artisan will appreciate that the current invention may be practised with communications networks different from the UMTS networks discussed below to illustrate the present invention. The invention may be practised with any network in which PTM services for content transmissions are provided. This may include any kind of wireless networks, for example networks based on WLAN (Wireless Local Area Network). This may, however, also include wireline networks, for example any kind of IP-based networks.

Those skilled in the art will further appreciate that functions explained hereinbelow may be implemented using individual hardware circuitry, using software functioning in conjunction with a programmed microprocessor or a general purpose computer, using an application specific integrated circuit (ASIC) and/or using one or more digital signal processors (DSPs). It will also be appreciated that while the current invention is described as a method, it may also be embodied in a computer processor and a memory coupled to a processor, wherein the memory is encoded with one or more programs that perform the methods disclosed herein when executed by the processor.

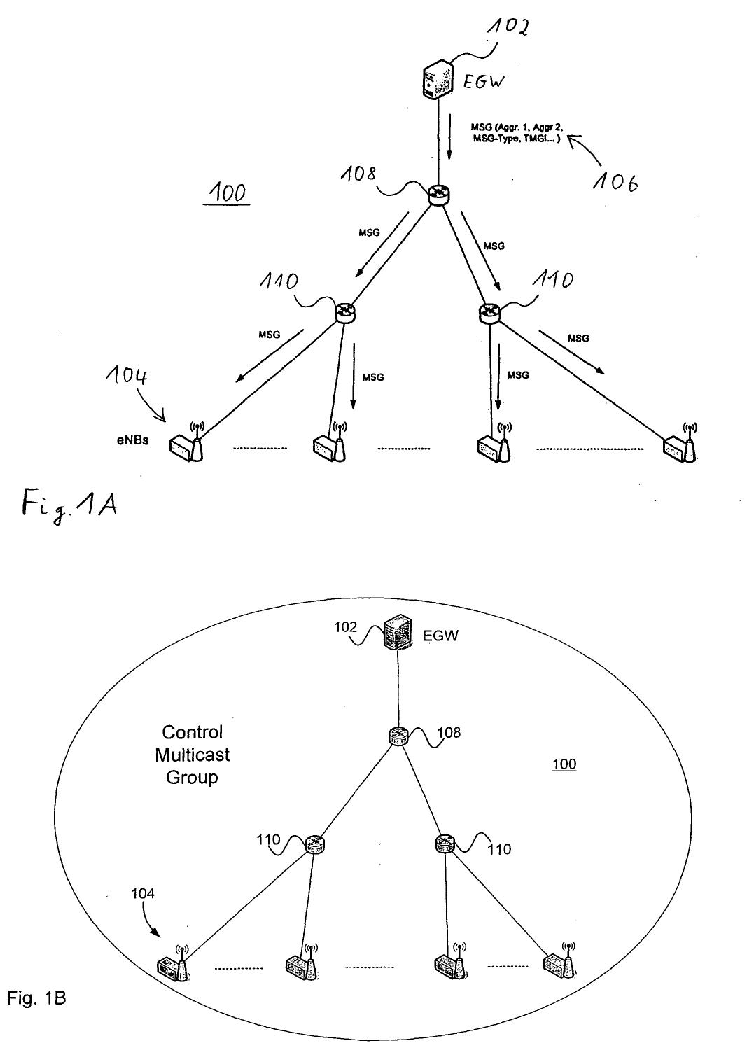

FIG. 1A illustrates an embodiment of a PTM-enabled network 100 comprising a PTM control node 102 and a plurality of network access nodes 104. The network 100 may be an UMTS LTE network, wherein the PTM control node 102 is implemented in an edge gateway (EGW), for example an evolved GGSN or a BM-SC, and the network access nodes are represented by evolved nodeBs (eNBs). It is generally intended that the term “node” when used herein may be understood as designating a “functional node”, i.e. designating a particular set of functions, rather than a physical node. The functions need not necessarily be implemented on a single physical node. As an example, the functions of a BM-SC may not be implemented on a dedicated standalone physical node, rather its functions might be provided co-located with other nodes. In general, the functions of a PTM control node may be implemented distributed over several physical nodes.

Referring back to FIG. 1A, a signalling message 106 is distributed from the edge gateway 102 over intermediate nodes 108 and 110 to the access nodes 104. The signalling 106 is intended for controlling a PTM content transmission. A service area (not shown) is associated with a PTM service used for the PTM content transmission. Some or all of the access nodes 104 belong to the service area. For example, the signalling message 106 may be an MBMS Session Start message for initiating an is MBMS multicast content transmission.

The signalling message 106 is distributed based on a PTM service, hereinafter referred to as a “PTM control service”, provided by the network 100. The PTM control service is different from the PTM service (“PTM content service”) used for the actual PTM content transmission. The access nodes 104 are the recipients of the PTM control service, which may be, for example, an MBMS multicast service. The distribution tree of the PTM control service may comprise several hierarchy levels, which are represented in the example depicted in FIG. 1A by the downstream nodes 108 and 110. As an example, the downstream nodes 108 and 110 may be routers which act to transparently forward the signalling message 106 towards the evolved NodeBs 104.

In principle, any signalling related to a PTM content transmission may be transported using the PTM control service. Assuming that the PTM content transmission is based on an MBMS service, in particular the MBMS Session Start, Session Stop and Session Update messages can be transported using an IP multicast group as the PTM control service. The network access nodes may be addressed within the signalling messages via service identifiers such as service area identifiers in MBMS. The service identifier is associated with a (potentially large) number of network access nodes 104. Vice versa, there may be multiple service identifiers associated with each access node 104. On reception of the signalling message 106 via a PTM control service, each of the nodes 104 determines if the indicated service identifier corresponds to a service identifier assigned to the node 104. If this is the case, the node 104 may prepare for the indicated PTM content transmission. If this is not the case, the node 104 may ignore (discard) the signalling message 106.

In one embodiment, some or all of the network access nodes of a (sub-)network may be members of a multicast group for the purpose of distributing signalling information related to the control of PTM content transmissions. Such a multicast group will be referred to as a “control multicast group” (CMG) hereinafter. A CMG for the network 100 of FIG. 1A is illustrated in FIG. 1B, in which like reference numerals designate like entities. The network components 102-110 of the network 100 are included (as indicated by the oval line) in a CMG. As an example, the CMG may be based on an IP multicast service, for example an MBMS service. The EGW forms the root and the access nodes form the leaves of the CMG distribution tree. In this way, any signalling related to different PTM content transmissions controlled by the node 102 and with service areas including at least some of the access nodes 104 may be distributed using the CMG depicted in FIG. 1B.

In large networks, it may be advisable to configure several separate CMGs. As an example, several CMGs might cover separate geographical areas. In case the service area of a PTM content service extends over several CMG areas, a PTM control node such as the edge gateway 102 in FIG. 1A, 1B has to initiate several CMGs. The service areas of different CMGs may be chosen according to other, non-geographical conditions. For instance, network access nodes with similar technical properties may be grouped accordingly in CMGs. As an example, all GSM access nodes, UMTS access nodes, and LTE access nodes may correspondingly be grouped together.

Each signalling message may contain at least one identifier unique for a CMG, e.g. a TMGI (Temporary Mobile Group Identity, see the 3GPP TS 23.246). Several service identifiers may be transported which are associated with different (e.g., localized) CMGs. In addition, one or more addresses of particular network access nodes may be included in a signalling message. The multicast group used for transporting the PTM content transmission (content or transport level multicast group, TLMG) has a separate multicast address, which is maintained by the edge gateway 102 (or a BM-SC not depicted in FIGS. 1A, 1B). The TLMG address is propagated down to the access nodes 104 using an appropriate CMG. Thus, a signalling message may contain the TLMG address for the PTM content transmission.

FIG. 1C schematically illustrates an embodiment of a mechanism for propagating signalling feedback for the network 100 of FIG. 1A. Again, like reference numerals designate like entities.

Each of the network access nodes 104 may determine if a received signalling message has to be processed or not based on information received in the signalling message. For example, a service identifier may be provided by the signalling. In case the service identifier is one which is also assigned to the access node, the node will provide a feedback to the PTM control node. Additionally or alternatively, the received signalling message may contain a network address of the access node, such that the node is directly addressed as being involved in the PTM content transmission.

To ensure a reliable and fast PTM content transmission, the access nodes 104 (all of which are assumed in FIG. 1C to belong to the service area of the content transmission) may be adapted to provide a feedback report towards the PTM control node 102 in response to the signalling message 106 (FIG. 1A). Apart from a direct response to a received signalling message, the terms “feedback”, “feedback report” or “feedback message” herein are intended to comprise any kind of information, which is related to signalling (which is in turn related to a PTM content transmission) and which is transmitted from the network access nodes “towards” (i.e., via one or more aggregation servers) the PTM control node.

Such a feedback may therefore not only include feedback reports sent in direct response to the reception of signalling information. Rather, a feedback may additionally or alternatively include, e.g., a report indicating a successful allocation of resources or a status report. Such a report may be transmitted towards the PTM control node on a regular basis (timer-based “heartbeat” status reporting). Status reports may also be triggered by particular events, for instance a change of available or used resources. As an example, a PTM bearer may have to be dropped during an ongoing content transmission due to a resource shortage. A feedback may also be triggered based on thresholds. As an example, the number of users served by a particular network access node may reach a particular threshold. As another example, the amount of available resources may fall below a predetermined threshold.

A signalling message may contain feedback control information such as a feedback request indicator. In case the indicator is set, this may command the network access node to send a feedback or to send a particular kind of feedback. In the absence of specific feedback control information from the PTM control node, the network access node may use default feedback control parameters in this respect.

As shown in FIG. 1C, the network access nodes 104 do not send their feedback directly to the PTM control node 102, but to feedback aggregation servers 112. These nodes are disposed separately from the signalling distribution tree depicted by the arrows (“MSG”) in FIG. 1A, i.e. they are excluded from the signalling distribution tree. The aggregation servers are adapted for being disposed separately from the signalling distribution tree. For example, they may be specifically adapted to receive and accept feedback messages, e.g. acknowledgement messages, without being the originator of the signalling messages, in response to which the feedback messages are transmitted. As an example, a feedback aggregation server may be adapted to accept feedback messages indicating one or more particular network access nodes as the sources of the feedback messages, or indicating a particular PTM control node as the final destination of the feedback.

Each of the feedback aggregation servers collects the feedback received from multiple access nodes 104 and provides an aggregated feedback towards the PTM control node 102. In the example illustrated in FIG. 1C, the aggregated feedback information of the aggregation servers 112 is not send directly to the control node 102, but is propagated to a higher-level aggregation server 114, which aggregates the aggregated feedback information again, such that a two-fold aggregated feedback information is eventually forwarded to the PTM control 102.

Within a multi-level hierarchy, each feedback aggregation server collects the feedback information from the lower level and forwards an aggregated feedback report to the next higher level. In other embodiments, a one-level hierarchy of aggregation servers may be utilized, for example in smaller networks and/or in case PTM content transmissions comprise a small service area only. For example, several feedback aggregation servers may be provided, which directly receive feedback from the network access nodes and which directly provide aggregated feedback information to the PTM control node. In another embodiment, only a single feedback aggregation server may be employed. Apart from the hierarchical structure depicted in FIG. 1C, the sub-network of feedback aggregation servers may be organized according to another topology. For example, a flat topology may be applied wherein each server receives feedback reports directly from the access nodes and transmits its aggregated feedback report directly to the PTM control node. The sub-network of feedback aggregation nodes may be organized independently, i.e. according to a completely different topology, from the sub-network formed by the PTM control node, the network access nodes and possibly further nodes such as routers.

In general, feedback aggregation servers may be co-located with other network nodes or may be provided as dedicated stand-alone entities. In FIG. 1C it is illustrated that the feedback aggregation servers 112, 114 are co-located with the routing nodes 110 and 108. In other embodiments, one or more of the aggregation servers may be co-located with network access nodes.

This is illustrated in FIG. 1D, in which a control multicast group may include an edge gateway 120 as root and network access nodes 121-125 as leaves. Two lower-level aggregation servers 126, 127 are provided for aggregating the feedback from the nodes 121-125. The servers 126 and 127 are co-located with the access nodes 122 and 123, respectively. For example, the access node 122 and the aggregation server 126 may be implemented on the same physical node. These physical nodes may receive assignment information which indicate an assignment of an aggregation functionality to the node, such that, e.g., the node hosting the network access node 122 additionally takes on the role of the feedback aggregation server 126.

The access nodes 121 and 122 are adapted to direct their feedback reports to the feedback aggregation server 126, whereas the access nodes 123, 124, 125 direct their feedback to the aggregation server 127. For example, each of the access nodes 121-125 may have a default aggregation server associated therewith, namely one of the servers 126 and 127.

The lower-level aggregation servers 126, 127 transmit their aggregated feedback reports to the high-level feedback aggregation server 128, which in turn transmits its two-fold aggregated feedback report to the PTM control node 120. Note that the hierarchy of aggregation servers (the “uplink hierarchy”) is independent from the hierarchy (the “downlink hierarchy”) in the signalling distribution tree from the root 120 towards the leaves 121-125. For example, in another embodiment the aggregation server 126 may provide its aggregated feedback report to the aggregation server 127 instead of the server 128. The server 127 may then provide an aggregated feedback report, which is based on the feedback from the access nodes 123-125 and the aggregated feedback report from the server 126 to the aggregation server 128. In still another embodiment, the server 128 may be omitted, and the aggregation server 127 may report directly to the PTM control node 120.

In still further embodiments, a PTM control node may have a co-located feedback aggregation server. Co-located nodes may be implemented on the same hardware entity with either dedicated or shared network interfaces. As an example, in a hierarchically organized sub-network of aggregation servers the aggregation server of highest level, i.e. next to the PTM control node, may be implemented on a common hardware platform with the PTM control node but with a processing hardware separate from that of the PTM control node to achieve the advantage of unburden the PTM control node from the processing of a massive amount of feedback information.

Referring back to FIG. 1C, the PTM control node 102 analyzes the received aggregated feedback report. A feedback report contained in a feedback message transmitted from a network access node may comprise only a minimum of information. For example, the feedback may comprise only the source address of the sender. Such a feedback report may for example serve as a “still alive” message, which contributes to ensuring the reliability of the ongoing content transmission. On the other hand, a feedback report may include information on the reception time of a signalling message, information on the number and identity of receiver units in the cell served by the network access node, information related to the available resources or resource usage for the content transmission and/or other services in relation to the access node, etc.

As the PTM control node 102 forms the root of the feedback aggregation tree, it depends on the details of the feedback aggregation scheme which of the feedback information provided by the network access nodes will arrive at the control node. The control node 102 may, e.g., determine, based on the aggregated feedback information, which of the network access nodes 104 have responded to the signalling message. In case one or more access nodes 104 have not responded, these nodes may not be listed in the received aggregated feedback status information. Then the transmission of the signalling message may have to be repeated to ensure reliability for the controlled PTM content transmission.

The access node may be assigned the functionality (the “role”) of a feedback aggregation server by administration of the network operator. Alternatively, a network node may receive an assignment information associated with, e.g., a signalling message related to a PTM content transmission, for example an MBMS Session Start message. Additionally or alternatively, dedicated feedback aggregation servers can be provided in the network. Multiple feedback aggregation servers may form a pool.

One or more feedback aggregation servers may be associated fixedly (e.g. via administration) with a PTM control node. As an example, in FIG. 1C, the aggregation servers 112 and 114 may be associated with the PTM control node 102 such that these particular aggregation servers serve to aggregate the feedback from the network access nodes 104 controlled by the control node 102. Additionally or alternatively, feedback aggregation servers may be assigned to a particular signalling context related to a PTM content transmission on request of the PTM control node. These and further mechanisms may be utilized to distribute the load over the aggregation servers available in the network and to avoid overload.

Referring back to FIG. 1A, the signalling message 106 may denominate the one or more feedback aggregation servers 112 to be used by the network access nodes 104 for feedback. Additionally or alternatively, an access node 104 may have one or more default aggregation servers. The provision of several aggregation servers to a network access node may be useful to ensure reliability, for example for redundancy reasons. In case of several available feedback aggregation servers, the access node 104 may apply an appropriate prescription to decide on the aggregation server to use, wherein the prescription ensures, e.g., load balancing aspects. For example, the access node 104 may randomly choose one of the available aggregation servers 112. Similar mechanisms may be applied for the low-level aggregation servers 112 to enable them identifying and selecting the high-level aggregation server 114.

The aggregation servers 112 may be made available to the access nodes 104 by providing, e.g., an IP-address or a logical host name. In case logical host names are provided to the access nodes 104, these may have to be resolved by a DNS (Domain Name Service) server. The (resolved) IP address may be an IP multicast or IP anycast address. Such an address may be associated with multiple feedback aggregation servers. For example, the IP address may designate a pool of aggregation servers 112, from which a particular aggregation server is chosen according to a prescription taking into account, e.g., load balancing aspects.

In FIGS. 1A-1D it is shown that the functionality of a PTM control node is implemented on an edge gateway. In principle, the functionality of the PTM control node may be implemented on a BM-SC (in an MBMS scenario) or on an edge gateway or both. In some embodiments it may be preferred to provide the PTM control node functionality in the BM-SC, in particular if a mapping of MBMS service areas and access nodes is maintained in the BM-SC.

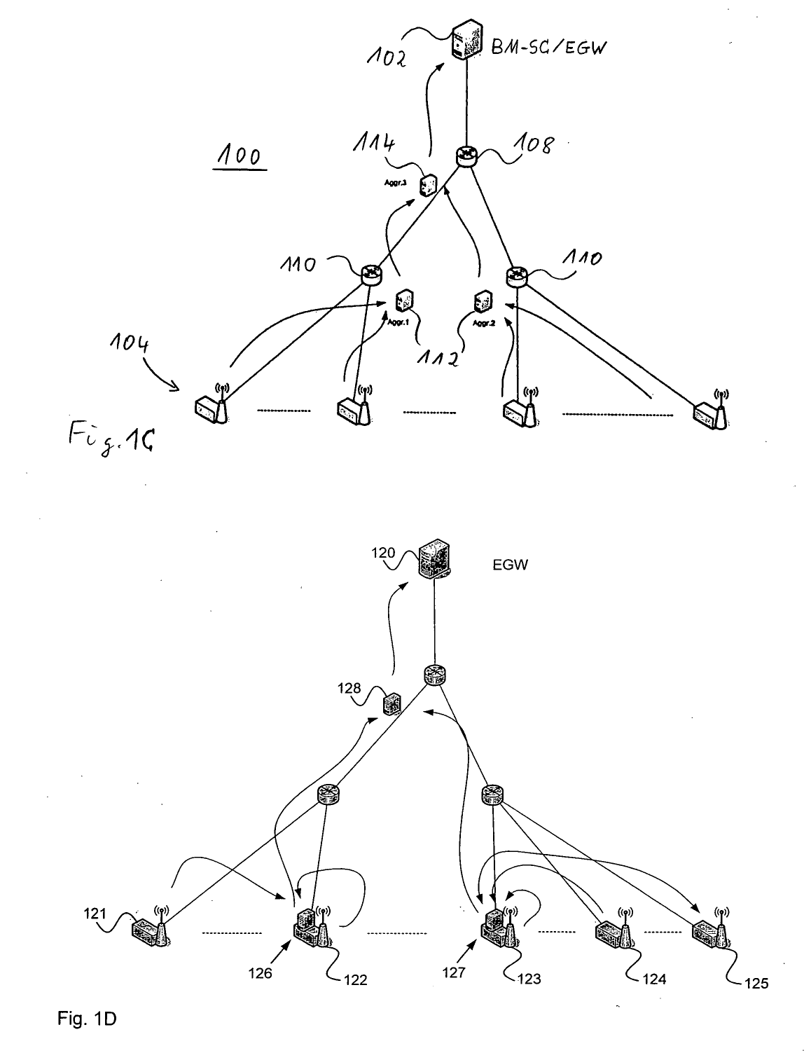

FIG. 2 schematically illustrates an embodiment of a feedback aggregation server 200 which may for example be an implementation of the aggregation servers 112 or 114 of FIG. 1C. The aggregation server 200 is adapted for a PTM-enabled network environment, in which signalling information related to a PTM content transmission is transmitted from a PTM control node along a downstream signalling distribution tree to a plurality of network access nodes. For example, the aggregation server 200 may be adapted for the network 100 of FIG. 1.

The aggregation server 200 comprises a reception component adapted for receiving feedback reports responsive to the signalling information from a plurality of senders. The feedback information may be received, e.g., from multiple access nodes. The reception component identifies the incoming information and provides the received feedback messages, acknowledgements, etc. to an aggregation component 204 which is adapted for aggregating the received feedback information into an aggregated feedback report. For example, the component 204 may buffer the feedback reports for a predetermined period of time before compiling an aggregated feedback report. Further, the aggregation component may extract particular information from the received feedback reports. For example, the component 204 may only extract the source addresses from the received feedback messages, e.g. the addresses of the sending access nodes. The aggregation component may then construct the aggregated feedback information from the extracted information.

The aggregation component 204 provides the aggregated feedback information to a transmission component 206 which is adapted for transmitting the aggregated feedback report. To this end, the component 206 may determine an address of either another aggregation server in a next-higher hierarchy level or the address of the PTM control node.

The aggregation server 200 may be co-located with, e.g., a network access node. In this case, the components 202, 204 and 206 may be implemented on the same hardware as the components of the network access node. This particular access node may then provide its feedback by internal messaging to the reception component 202. Further, the aggregation server 200 may be associated with a particular PTM control node, e.g. by storing the address of the PTM control node in a storage component of the aggregation server 200 via an administration interface. In this case, the component 206 might simply insert the stored address into a message including the aggregated feedback information.

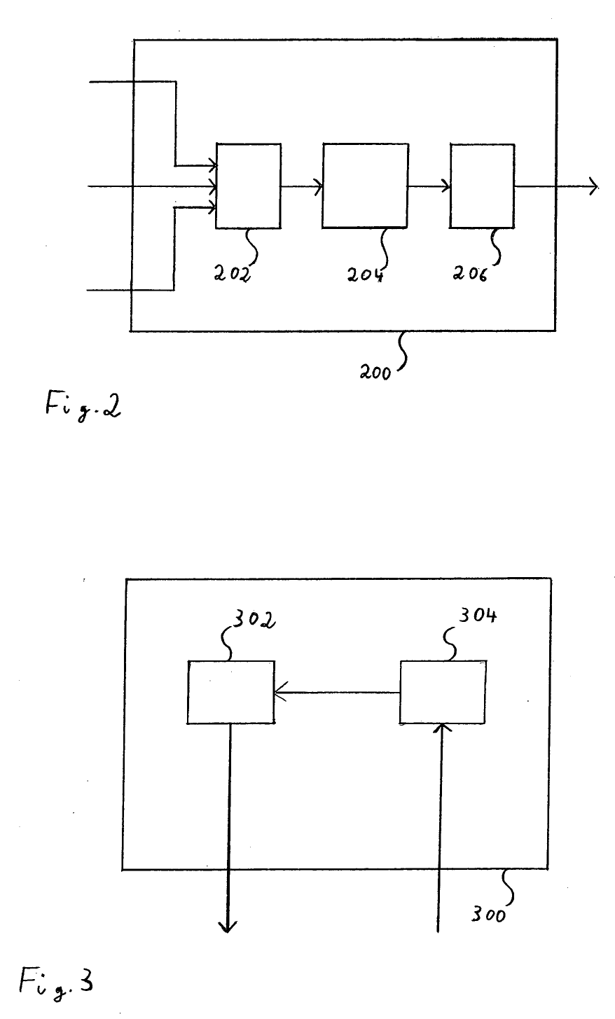

FIG. 3 schematically illustrates an embodiment of a PTM control node 300 which may for example be an implementation of the control node 102 of FIG. 1B. The control node 300 may be implemented on a BM-SC of an UMTS or LTE network or may be implemented on an edge gateway, e.g. an evolved GGSN, of such a network. The functionality of the PTM control node 300 may also be implemented distributedly on a BM-SC and an edge gateway.

The PTM control node 300 is adapted for controlling PTM content transmissions in a PTM-enabled network environment, e.g. in the network 100 in FIG. 1. The PTM control node 300 comprises a transmission component 302 which is adapted for transmitting signalling information related to a PTM content transmission along a downstream signalling distribution tree to a plurality of network access nodes. As an example, the component 302 may prepare and transmit MBMS session related signalling messages such as Session Start and Session Stop messages. The transmission component may initiate one or more PTM control services in this regard.

The control node 300 further comprises a reception component 304 which is adapted for receiving, in response to the signalling information, an aggregated feedback report from a feedback aggregation server separate from the downstream signalling distribution tree, such as the aggregation server 200 of FIG. 2 or server 114 of FIG. 1C. The aggregated feedback report is indicative of feedback reports from the plurality of network access nodes related to the signalling information. The aggregated feedback information may influence further signalling related to the PTM content transmission. For example, an analysis of the aggregated feedback information may trigger a repetition of the signalling message transmission at the component 302.

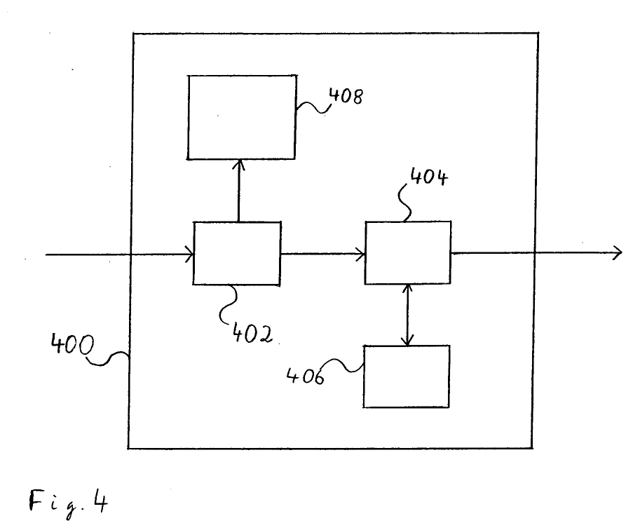

FIG. 4 schematically illustrates an embodiment of a network access node 400 which is adapted for handling PTM content transmissions in a PTM-enabled network environment. The access node 400 may for example be a representation of the nodes 104 in FIGS. 1A, 1B, 1C or 121-125 in FIG. 1D.

The access node 400 comprises a reception component 402 which is adapted for receiving signalling information related to a PTM content transmission from a PTM control node (for example the node 102 of FIG. 1), wherein the signalling information is received along a downstream signalling distribution tree. In response to the received signalling information, the access node 400 may provide a feedback report towards the PTM control node, which may at least indicate an identity of the access node.

The reception component 402 may trigger a transmission component 404, which is adapted for transmitting a feedback report related to the signalling information to the feedback aggregation server. The reception component 402 may either trigger the transmission component 404 in direct response to a received signalling information, and/or may trigger the component 404 on a periodical basis or in response to further events.

The transmission component 404 may trigger a determination component 404, which is adapted for determining a feedback aggregation server, wherein the feedback aggregation server is separate from the downstream signalling distribution tree. The determination component 404 may for example be adapted to read the address of a default aggregation server from a storage component of the access node 400 (not shown) or to extract the address of an aggregation server from a buffered signalling message. In case that several addresses are available to the address component 404, an implemented decision algorithm decides on the particular address to use.

The determination component 406 provides the determined address of the feedback aggregation server to the transmission component 404, which may construct a feedback message with the determined address of the feedback aggregation node as the destination address and a network address of the access node 400 as the source address, such that the source address serves as the identity indication for the access node 400. In other embodiments, further information may be inserted into the feedback report, such as an indication of the signalling message and/or PTM content transmission, to which the feedback is related. The transmission component 406 then transmits the feedback report to the address of the feedback aggregation server.

The reception component 402 may, on reception of the signalling information, further trigger a content-handling component 408, which is adapted for handling the content distributed by the PTM content transmission. In particular, the component 408 is adapted for receiving and forwarding the content to multiple recipients. The trigger from the reception component 402 may, for example, serve to prepare the reception of the PTM content transmission in the component 408. In other cases, the trigger may lead to a re-configuration of resources controlled by the component 408 during an ongoing PTM content transmission or when the content transmission is stopped.

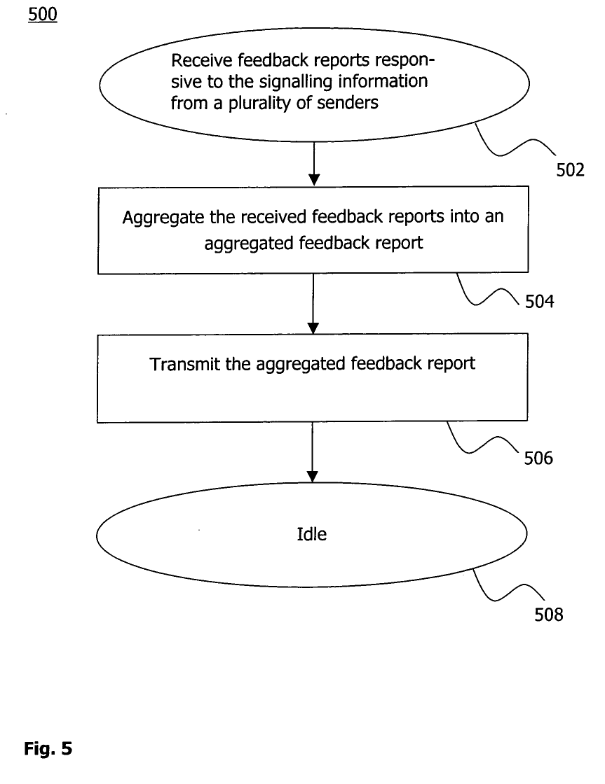

FIG. 5 schematically illustrates the steps of an embodiment of a method 500 of operating a feedback aggregation server, for example the nodes 112 or 114 in FIG. 1C or the node 200 of FIG. 2, in a PTM-enabled network environment such as the network 100 in FIG. 1C, in which signalling information related to a PTM content transmission is transmitted from a PTM control node along a downstream signalling distribution tree to a plurality of network access nodes.

In step 502, the method is triggered, for example, by a timer, by a counter or by the reception of feedback reports responsive to the signalling information from a plurality of senders. In step 504, the received feedback reports are aggregated into an aggregated feedback report; for example, the source addresses of each of the received feedback reports may be extracted and collected in a list. In step 506, the aggregated feedback information is transmitted, for instance to a PTM control node or to another aggregation server. In step 508, the method ends with the feedback aggregation server being idle and waiting for further feedback to be received.

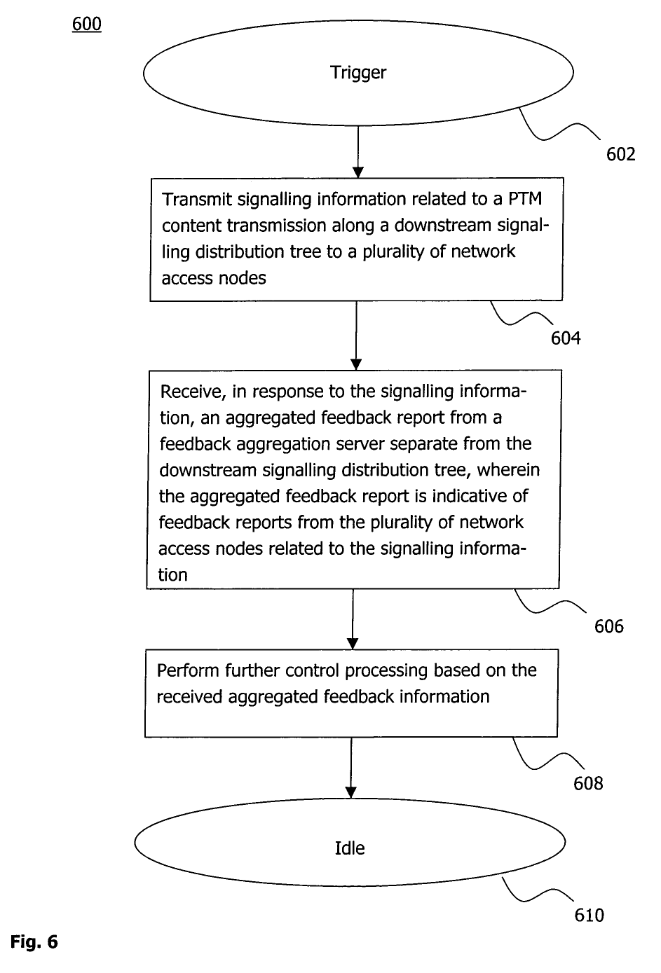

FIG. 6 schematically illustrates the steps of an embodiment of a method 600 for controlling PTM content transmissions in a PTM-enabled network environment. The method may be performed in a PTM control node, for example the edge gateway in 102 in FIGS. 1B, 1C or the node 300 in FIG. 3.

The method is triggered in step 602; for example, a PTM content transmission may be queued for processing. In step 604, signalling information related to the PTM content transmission is transmitted along a downstream signalling distribution tree to a plurality of network access nodes. The signalling information may be related to the start, a reconfiguration or the end of the content transmission. In step 606, an aggregated feedback information is received in response to the signalling information from a feedback aggregation server separate from the downstream signalling distribution tree. The aggregated feedback information is indicative of feedback reports from the plurality of network access nodes related to the signalling information.

In step 608, some further control processing related to the PTM content transmission is performed, which is based on the received aggregated feedback information. For example, a repetition of the signalling transmission may be queued at least to some access nodes which missed the first transmission. The method ends in step 610 with the PTM control node being idle and waiting for further triggering events.

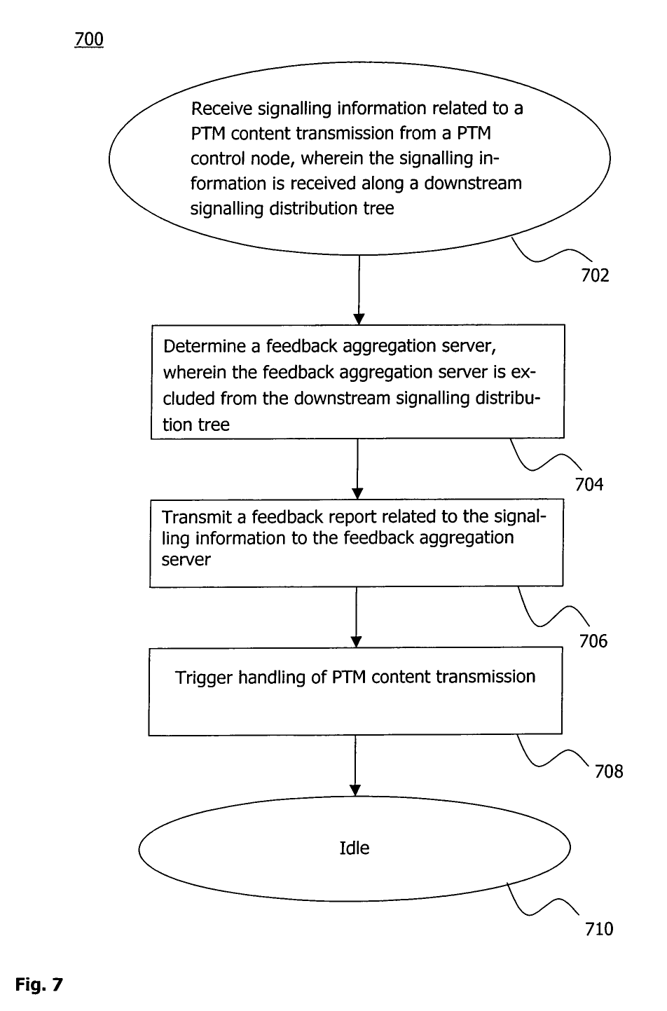

FIG. 7 schematically illustrates the steps of an embodiment of a method 700 of operating a network access node, for example the nodes 104 in FIG. 1B or node 400 of FIG. 4, for handling PTM content transmissions in a PTM-enabled network environment.

The method is triggered in step 702 by the reception of signalling information related to a PTM content transmission from a PTM control node. The method may also be triggered, e.g., by the expiry of a timer. The signalling information is received along a downstream signalling distribution tree with the PTM control node forming the root of the tree.

In step 704, a feedback aggregation server is determined, wherein the feedback aggregation server is separate from the downstream signalling distribution tree. An address of the server may be determined, e.g., a default address or an address received with the signalling information. In step 706, a feedback report related to the signalling information is transmitted to the feedback aggregation server. In step 708, the handling of the PTM content transmission is triggered. For example, the received signalling information may be related to the start of a PTM content transmission. The step 708 may then trigger a preparation of the reception of the PTM content transmission in the network access node, as well as its forwarding to the intended recipients of the content. For example, appropriate resources may be allocated. The method ends in step 710.

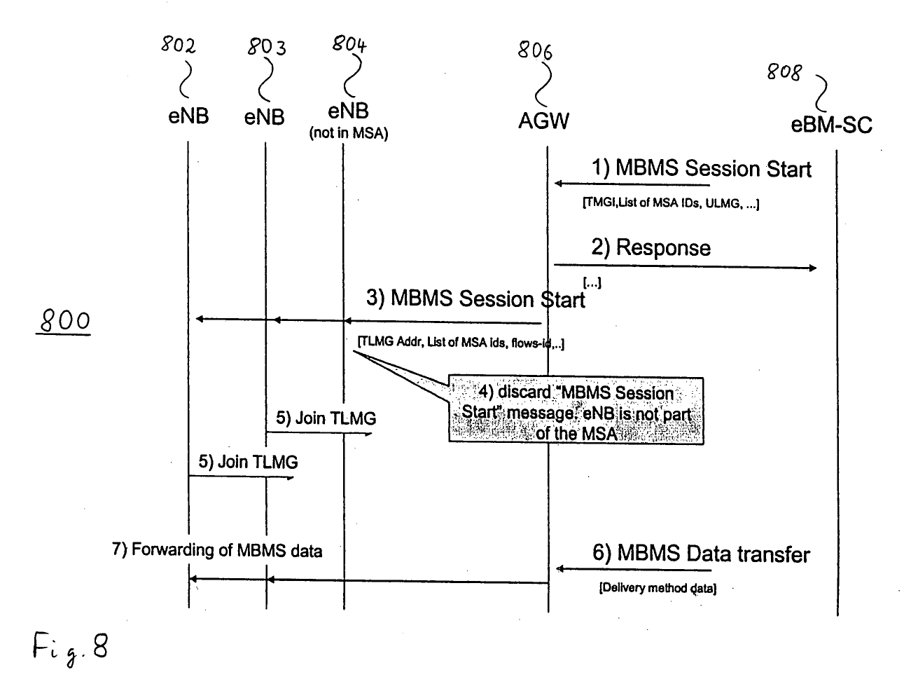

FIG. 8 schematically illustrates an embodiment of a message sequence 800 in an LTE network, which involves a number of network access nodes (evolved NodeBs) 802, 803, 804, an edge gateway (access gateway, AGW) 806 and an evolved BM-SC 808. A PTM control node functionality is implemented distributedly on the nodes 806 and 808.

In step 1), the evolved BM-SC 808 transmits an MBMS session start message to the edge gateway 806 in order to trigger the establishment of an MBMS distribution plane for an MBMS content transmission. The message comprises a TMGI identifying the user level group, one or more MBMS service area identifiers, and a user-level multicast group address. In addition, one or more flow IDs may be included in the session start message, for example if several traffic flows have to be multiplexed on the multicast group. As an example, several UDP (User Datagram Protocol) destination ports may be indicated. An indication of one or more (localized) CMGs may be included. The message may further contain a feedback request indication as described above.

In step 2), the edge gateway acknowledges reception of the MBMS session start message. In step 3), the edge gateway 806 acts as a PTM control node and determines the CMG(s) to use for distribution of the MBMS Session Start message. The CMG(s) may have been indicated in the message in step 1), or the edge gateway 806 may derive the CMGs from the received MBMS service area identifier(s). A derivation algorithm may be provided to the edge gateway 804 in this respect, which may scan a corresponding mapping table. In step 4), the MBMS Session Start message including the service area identifier(s) is then propagated along the downstream signalling distribution tree towards the network access nodes 802, 803, 804 using one or more MBMS multicast services associated with the indicated or derived CMGs. No PTP connections need to be initiated for signalling purposes. However, the edge gateway 806 may set up unicast connections to one or few access nodes for signalling purposes, e.g. if these access nodes are not member in the CMG(s).

In the example illustrated in FIG. 8, it is assumed that all evolved NodeBs 802-804 receive the MBMS Session Start message. In case a network access node does not belong to the indicated MBMS service area(s), it may discard the signalling message. This is the case for node 804. The service area IDs may have been assigned to the access nodes via an administrative action. In step 5), the access nodes 802 and 803 join the TLMG, as they have one of the service areas indicated in the Session Start message assigned with it. For example, they may send a query message to the TLMG group, e.g. an IGMP (IP Group Management Protocol) message.

In step 6), the BM-SC 808 starts to transmit content data to the TLMG. The edge gateway 806 encapsulates the TLMG traffic and tunnels it to the network access nodes 802 and 803. The TLMG indication is used for routing in the core network. If present, a flow-ID may be added as a tunnelling header. In case the flow-ID is to be used in step 6), it has to be signalled in step 3). In step 7), the network access nodes 802 and 803 receive the content and transmit the content utilizing appropriate radio bearers chosen according to the TLMG and the optional flow-ID. The steps 6) and 7) thus constitute a PTM content transmission.

The techniques proposed herein allow a reduction of the processing burden of PTM control nodes, such as a BM-SC in an MBMS framework or a network node acting as an edge gateway, when controlling PTM content transmissions. For example, transmitting-related signalling information utilizing a PTM service of a network environment allows avoiding the processing overhead associated with setting up a possibly large number of parallel unicast connections. The concept of control multicast groups (CMGs) is based on defining multicast groups which may be used for signalling purposes only. One or few CMGS only may be required per network, as the service area of a CMG can be larger or smaller than the service area of a PTM content transmission.

The concept of feedback aggregation by using an aggregation server or a network of aggregation servers, which may be organized hierarchically and may be separated from the network structure used for the signalling (and the content transmission), allows to reduce the burden of the PTM control node with processing a possibly massive amount of feedback information. The PTM control node typically will receive only one or few aggregated feedback messages. A sub-network of aggregation servers may be dynamically adapted to the requirements of content transmissions momentarily performed in the network environment.

While the current invention has been described in relation to its preferred embodiments, it is to be understood that this disclosure is for illustrative purposes only. Accordingly, it is intended that the invention be limited only by the scope of the claims appended hereto.

1. A method for controlling point-to-multipoint (PTM) content transmissions in a PTM-enabled network environment, the method comprising the steps of:
transmitting signalling information related to a PTM content transmission along a downstream signalling distribution tree to a plurality of network access nodes, wherein the signalling information indicates a multicast address for use by the network access nodes for transmitting feedback reports; and
receiving, in response to the signalling information, an aggregated feedback report from a feedback aggregation server separate from the downstream signalling distribution tree, wherein the aggregated feedback report is indicative of feedback reports from the plurality of network access nodes related to the signalling information.

2. The method according to claim 1, wherein the multicast address is associated with multiple feedback aggregation servers.

3. The method according to claim 1, comprising the further step of repeating, based on an evaluation of the received aggregated feedback report, the transmission of the signalling information.

4. The method according to claim 3, wherein the repeated transmission of the signalling information is performed based on point-to-point service of the network environment.

5. The method according to claim 1, wherein the signalling information comprises a feedback request indication.

6. The method according to claim 1, wherein the signalling information is transmitted using a PTM service of the network environment.

7. A method of operating a network access node for handling point-to-multipoint (PTM) content transmissions in a PTM-enabled network environment, the method comprising the steps of:
receiving signalling information related to a PTM content transmission from a PTM control node, wherein the signalling information is received along a downstream signalling distribution tree and the signaling information indicates a multicast address;
determining a feedback aggregation server separate from the downstream signalling distribution tree according to the multicast address; and
transmitting a feedback report related to the signalling information to the feedback aggregation server using the multicast address.

8. The method according to claim 7, wherein the multicast address is associated with multiple feedback aggregation servers.

9. The method according to claim 7, wherein an address of the feedback aggregation server is different from an address of the PTM control f)ode.

10. The method according to claim 7, wherein the feedback report comprises at least one of an acknowledgement of received signalling information, an indication of a result of a process triggered by the received signalling information and status information related to the PTM content transmission.

11. The method according to claim 7, wherein the signalling information is received based on a first PTM service of the network environment.

12. The method according to claim 11, wherein the received signalling information comprises a service identifier, and the method comprises, based on the service identifier, the step of identifying, a second PTM service of the network environment for the PTM content transmission.

13. A method of operating a feedback aggregation server, in a point-to-multipoint (PTM) enabled network environment, in which signalling information related to a PTM content transmission is transmitted from a PTM control node along a down stream signalling distribution tree to a plurality of network access nodes and wherein the signaling information indicates a multicast address for use by the network access nodes for transmitting feedback reports, the method comprising the steps of:
receiving feedback reports responsive to the signalling information from a plurality of senders;
aggregating the received feedback reports into an aggregated feedback report; and
transmitting the aggregated feedback report wherein the feedback aggregation server is separate from the downstream signaling distribution tree.

14. The method according to claim 13, further comprising, receiving an indication of at least one of the PTM control node and a higher-level feedback aggregation server as a destination for the aggregated feedback report.

15. The method according to claim 14, wherein the indication comprises an indication of a multicast address associated with multiple higher-level feedback aggregation servers.

16. The method according to claim 13, comprising the step of selecting one server from a list of higher-level feedback aggregation servers.

17. The method according to claim 13 comprising the further step of receiving assignment information indicating an assignment of an aggregation server functionality to the receiving node.

18. The method according to claim 13 wherein the aggregated feedback report is transmitted at predetermined time intervals.

19. The method according to claim 13, wherein the plurality of senders comprise at least one of
one or more of the plurality of network access nodes and
one or more lower-level feedback aggregation servers.

20-21. (canceled)

22. A PTM control node adapted for controlling point-to-multipoint (PTM) content transmissions in a PTM-enabled network environment, the PTM control node comprising:
a transmission component adapted for transmitting signaling information related to a PTM content transmission along a downstream signalling distribution tree to a plurality of network access nodes, wherein the signalling information indicates a multicast address for use by the network access nodes for transmitting feedback reports; and
a reception component adapted for receiving, in response to the signalling information, an aggregated feedback report from a feedback aggregation server separate from the downstream signaling distribution tree, wherein the aggregated feedback report is indicative of feedback reports from the plurality of network access nodes related to the signalling information.

23. The PTM control node according to claim 22, wherein the transmission component is adapted for transmitting the signaling information based on a PTM service of the network environment.

24. A network access node adapted handling point-to-multipoint (PTM) content transmissions in a PTM-enabled network environment, the network access node comprising:
a reception component adapted for receiving signalling information related to a PTM content transmission from a PTM control modem, wherein the signalling information is received along a downstream signalling distribution tree and the signalling information indicates a multicast address;.
a determination component adapted for determining a feedback aggregation server separate from the downstream signaling distribution tree according to the multicast address; and
a transmission component adapted for transmitting a feedback report related to the signalling information to the feedback aggregation server using the multicast address.

25. A feedback aggregation server adapted for a PTM-enabled network environment, in which signaling information related to a PTM content transmission is transmitted from a PTM control node along a downstream signalling distribution tree to a plurality of network access nodes and the signalling information indicates a multicast address for use by the network access nodes for transmitting feedback reports, the feedback aggregation server comprising:
a reception component adapted for receiving feedback reports responsive to the signalling information from a plurality of senders;
an aggregation component adapted for aggregating the received feedback reports into an aggregated feedback report; and
a transmission component adapted for transmitting the aggregated feedback report, wherein the feedback aggregation server is separate from the downstream signaling distribution tree.

26. The feedback aggregation server according to claim 25, wherein the feedback aggregation server is co-located with a network access node.

27. The feedback aggregation server according to claim 25, wherein the feedback aggregation server is associated with a PTM control node.
